(19) United States
(12) Patent Application Publication
(10) Pub. No.: US 2025/0306971 A1
(43) Pub. Date: Oct. 2, 2025

(54) FIRMWARE PARTITIONING FOR EFFICIENT WORLD SWITCH

(71) Applicant: ATI Technologies ULC, Markham (CA)

(72) Inventor: Ahmed M. Abdelkhalek, Markham (CA)

(73) Assignee: ATI Technologies ULC, Markham (CA)

(21) Appl. No.: 18/621,676

(22) Filed: Mar. 29, 2024

(51) Int. Cl. G06F 9/455; G06F 9/4401

(52) U.S. Cl. CPC G06F 9/45558; G06F 9/4401

(57) ABSTRACT

A technique for performing virtualization operations on a device is disclosed. The technique utilizes a generic firmware portion and virtual function specific firmware portions to improve the performance during world switches. More specifically, when world switches are performed, the device maintains a generic firmware portion while replacing a virtual function specific firmware portion. The generic firmware portion includes operations that are common between different virtual functions, while the virtual function specific firmware portions include operations that vary between different virtual functions. This scheme reduces the number of operations that occur for a world switch, improving performance, and allows different virtual functions to have different functionality.

### BACKGROUND

Computer virtualization is a technique in which a single set of hardware is shared among different virtual instances of a computer system. Each instance-a virtual machine (“VM”)—believes that it owns a whole, hardware computer system, but in reality, the hardware resources of a computer system are shared among the different VMs. Advances in virtualization, including advances in virtualization for devices other than the CPU, system memory, and the like, are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 illustrates details of the device and the APD, according to an example;

FIG. 3 is a block diagram showing additional details of the graphics processing pipeline illustrated in FIG. 2, according to an example;

FIG. 4 illustrates an APD firmware system, according to an example;

FIGS. 5A-5C illustrate example operations for loading firmware into the command processor; and

FIG. 6 is a flow diagram of a method for operating an APD, according to an example.

### DETAILED DESCRIPTION

A technique for performing virtualization operations on a device is disclosed. The technique utilizes a generic firmware portion and virtual function specific firmware portions to improve the performance during world switches. More specifically, when world switches are performed, the device maintains a generic firmware portion while replacing a virtual function specific firmware portion. The generic firmware portion includes operations that are common between different virtual functions, while the virtual function specific firmware portions include operations that vary between different virtual functions. This scheme reduces the number of operations that occur for a world switch, improving performance.

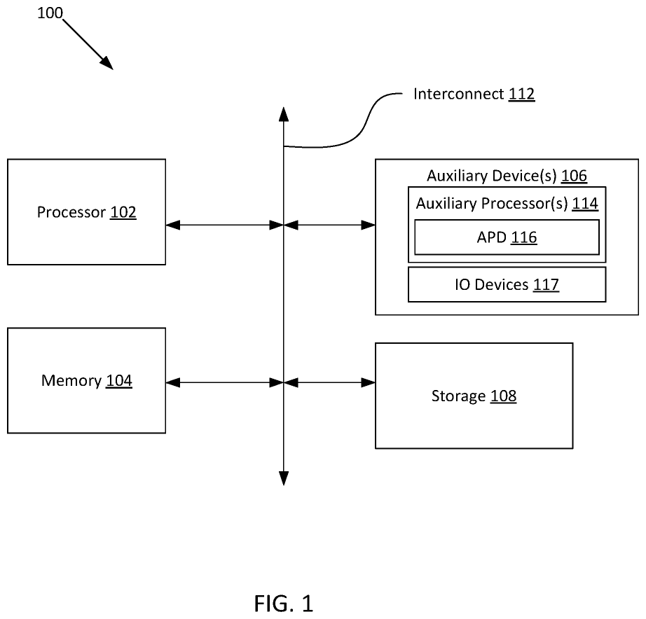

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units (e.g., the compute units 132) configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

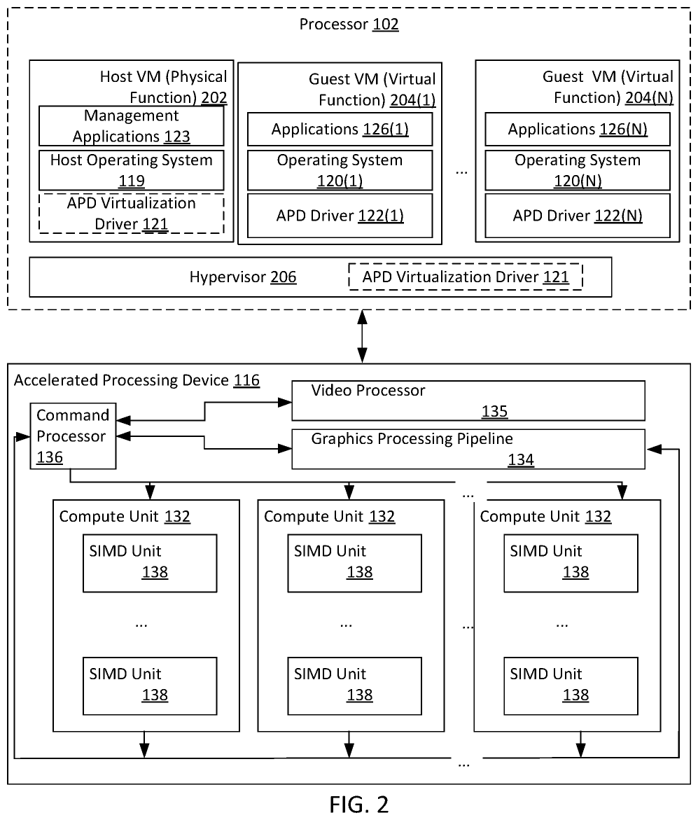

FIG. 2 illustrates details of the device 100 and the APD 116, according to an example. The APD 116 executes commands and programs for selected functions, such as video encoding or decoding, graphics operations, and non-graphics operations that may be suited for parallel processing. The APD 116 can be used for executing video operations, graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102. A command processor 136 accepts commands from the processor 102 (or another source), and delegates tasks associated with those commands to the various elements of the APD 116 such as the graphics processing pipeline 134, the compute units 132, and the video processor 135.

Although the APD 116 is described as having both graphics and video functionality, implementations of the APD 116 are contemplated in which the APD 116 has video functionality and not graphics functionality (which includes functionality of the compute units 132 and of the graphics processing pipeline 134, including compute kernels as well as graphics pipeline functionality), graphics functionality and not video functionality, or both graphics functionality and video functionality. In addition, an implementation of the APD 116 is contemplated in which neither graphics functionality nor video functionality is performed. In any such example, the command processor 136 accepts commands to perform “jobs” (such as graphics tasks, compute tasks, or video encoding or decoding tasks) and performs those commands accordingly.

The APD 116 includes compute units 132 that include one or more SIMD units 138 that are configured to perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A command processor 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The video processor 135 performs one or both of video encoding and video decoding. Video encoding is a compression process for video, which is a series of frames. Though there are many possible techniques for encoding, a popular set of encoding techniques involves performing intra or inter prediction to obtain a residual and an indication of a reference block in a prediction step, as well as encoding the residual using a discrete cosine transform and entropy coding. In corresponding decoding techniques, the decoder decodes the entropy coded information to obtain discrete cosine transform coefficients for a residual and applies the residual to a reference block to reconstruct the original block. Any of a variety of encoding or decoding techniques may be used.

The processor 102 supports multiple virtual machines. A specialized host virtual machine 202, is not a “general purpose” VM like the guest VMs 204, but instead performs support for virtualization of the APD 116 for use by the guest VMs 204. A hypervisor 206 provides virtualization support for the virtual machines, which includes a wide variety of functions such as managing resources assigned to the virtual machines, spawning and killing virtual machines, handling system calls, managing access to peripheral devices, managing memory and page tables, and various other functions.

The APD 116 supports virtualization by allowing sharing (e.g., time-based sharing) of the APD 116 between the virtual machines. On the APD 116, the host VM 202 is mapped to a physical function 208 and guest VMs 204 are mapped to virtual functions 210. “Physical functions” are an addressing parameter in the peripheral component interconnect express (“PCIe”) standard. More specifically, physical functions allow communications involving a device coupled to a PCIe interconnect fabric to specify a particular physical function of the device so that the device is able to handle the communications according to functionality specifically assigned to that physical function. Herein, a single physical function is described, but the teachings of the present disclosure apply to APDs 116 for which more than one physical function is active.

Virtual functions are a feature of the PCIe standard that facilitates hardware virtualization and also acts as an addressing parameter in the PCIe standard. Typically, a set of virtual functions is associated with a particular physical function. In some examples, each virtual machine is assigned a different virtual function, with the hypervisor 206 managing the correlation between VMs and virtual functions. In FIG. 2, the guest VMs 204 are limited to accessing respective virtual functions, while the host VM 202 has broader access, being able to access the physical function as well as each of the virtual functions.

As described above, physical functions and virtual functions are addressing parameters in PCIe, where transactions made across PCIe specify or are intended for/associated with a particular virtual function and/or physical function and the processor 102 or APD 116 responds accordingly. The processor 102 directs transactions for a particular VM to the appropriate virtual function of the APD 116 via a memory mapping mechanism. More specifically, when a virtual machine makes an access to the APD 116, the memory address used to make that access is translated from a guest physical address to a system physical address. The particular system physical address used is mapped to a particular virtual function of the APD 116 by a memory mapping mechanism and thus the transaction made is routed to the APD 116 and appropriate virtual function via the mapping information. PCIe has different addressing modes. In some such modes, the virtual function or physical function is explicitly addressed, while in others, the mapping from virtual machine to physical or virtual function occurs as a result of the PCIe routing system “remembering” correlations between virtual machine and virtual function.

Note that although virtualization is described with respect to the PCIe communication protocol, those of skill in the art should understand that PCIe is not a necessary feature of the techniques described herein and that any communication protocol compatible with virtualization of a device (e.g., APD 116) can be used.

In some examples, sharing the APD 116 among the different virtual machines is accomplished by time-dividing the operations of the APD 116 amongst the different virtual machines. The command processor 136 performs this task, scheduling different virtual machines for operation by switching between work for the different virtual machines as the execution time assigned to the virtual machines elapses. Although the APD 116 is shared among the different virtual machines, each virtual machine perceives that it has an individual instance of a real, hardware APD 116. Although the terms “virtual function” and “physical function” refer to addressing parameters of the PCIe standard, because these functions map to different VMs, the logical instance of an APD 116 assigned to a particular virtual machine will also be referred to herein as either a virtual function or a physical function. In other words, this disclosure may use terminology such as “the virtual function performs a task,” (or physical function) or “an operation is performed on of for a virtual function,” (or physical function) and this terminology should be read to mean that the APD 116 performs that task for the VM corresponding to that particular virtual or physical function.

The host VM 202 has a host operating system 119 and the guest VMs 204 have operating systems 120. The host VM 202 has management applications 123 and an APD virtualization driver 121. The guest VMs 204 have applications 126, an operating system 120, and an APD driver 122. These elements control various features of the operation of the processor 102 and the APD 116.

As stated above, the host VM 202 configures aspects of virtualization in the APD 116 for the guest VMs 204. Thus the host VM 202 includes a host operating system 119 that supports execution of other elements such as management applications 123 and a APD virtualization driver 121. The APD virtualization driver 121 communicates with the APD 116 to configure various aspects of the APD 116 for virtualization. In one example, the APD virtualization driver 121 manages parameters related to the time-slicing mechanism for sharing the APD 116 among the different VMs, controlling parameters such as how much time is in each time-slice, how switching is performed between different virtual functions, and other aspects.

The management applications 123 perform one or more tasks for managing virtualization and/or that involve data from two or more different guest VMs 204. In one example, the host VM 202 performs a desktop compositing function through a management application 123, where the desktop compositing function has access to rendered frames from the different guest VMs 204 and composites those frames into a single output view.

The guest VMs 204 include an operating system 120, an APD driver 122, and applications 126. The operating system 120 is any type of operating system that could execute on processor 102. The APD driver 122 controls operation of the APD 116 for the guest VM 204 on which the APD driver 122 is running, sending tasks such as video encoding or decoding tasks, graphics rendering tasks or other work to the APD 116 for processing.

Although the APD virtualization driver 121 is described as being included within the host VM 202, in other implementations, the APD virtualization driver 121 is included in the hypervisor instead 206. In such implementations, the host VM 202 may not exist and functionality of the host VM 202 may be performed by the hypervisor 206.

The operating systems 120 of the host VM 202 and the guest VMs 204 perform standard functionality for operating systems in a virtualized environment, such as communicating with hardware, managing resources and a file system, managing virtual memory, managing a network stack, and many other functions. The APD driver 122 controls operation of the APD 116 for any particular guest VM 204 by, for example, providing an application programming interface (“API”) to software (e.g., applications 126) to access various functionality of the APD 116. For any particular guest VM 204, the APD driver 122 controls functionality on the APD 116 related to that guest VM 204, and not for other VMs.

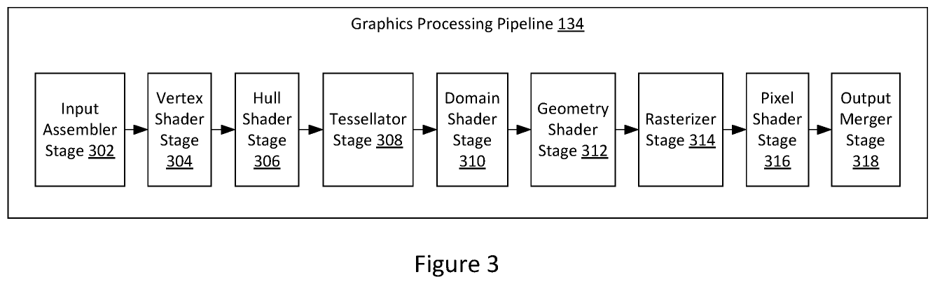

FIG. 3 is a block diagram showing additional details of the graphics processing pipeline 134 illustrated in FIG. 2, according to an example. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

Among other things, the drivers (e.g., virtualization driver 121 and APD driver 122) control what firmware is executed on the command processor 136. The command processor 136 includes a programmable processor that executes firmware to perform a variety of operations on the APD 116. Some examples of such operations include initialization of the APD 116 on startup, generic queue handling operations (e.g., reading to a queue or writing from a queue such as a queue into which the processor 102 places job commands for execution by the APD 116), generic job command processing operations (e.g., operations for processing such job commands on the APD 116), job completion reporting code (e.g., code for reporting to the processor 102 that jobs are complete), code for controlling aspects of the APD 116, operations for performing rendering operations, performing compute operations, or performing other types of operations.

In some implementations, each different virtual function (“VF”) has a VF-specific firmware that is to execute on the APD 116. Thus, upon performing a world switch on the APD 116, the APD 116 loads the VF-specific firmware for the now-executing virtual function. A world switch is an operation that switches which virtual function's operations are being performed on the APD 116. More specifically, as described elsewhere herein, the APD 116 services multiple VMs 204 by time-switching between servicing the different VMs 204. Changing which VM 204 is being serviced (and thus which VF is being serviced) is referred to as a world switch herein. As each guest VM 204 specifies their own firmware, the firmware executing for any given VF 204 changes when a world switch occurs.

It is possible to change the entirety of the firmware executing on the APD 116 when a world-switch occurs. However, because there is a lot of overlap in functionality between different firmware versions for different VMs 204, a different approach is disclosed herein.

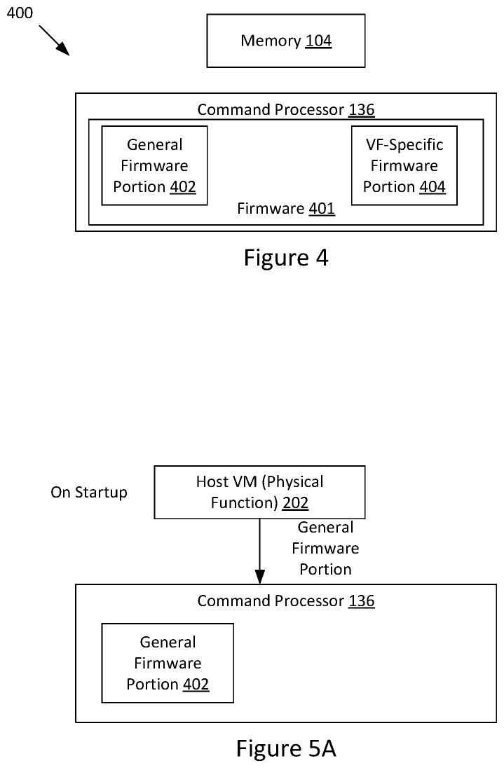

FIG. 4 illustrates an APD 116 firmware system 400, according to an example. The command processor 136 is illustrated with firmware 401 loaded. Both the general firmware portion 402 and the VF-specific firmware portion 404 are used to perform work for the APD 116, such as processing job commands transmitted from a guest VM 204 to the APD 116 for execution. However, during a world-switch, the command processor 136 does not switch out the general firmware portion 402, but does switch out the VF-specific firmware portion 404. More specifically, for a world switch from a first guest VM 204 to a second guest VM 204, the command processor 136 overwrites the VF-specific firmware portion with the VF-specific firmware portion 404 of the second guest VM 204. Then, the command processor 136 operates the APD 116 with the general firmware portion 402 and the newly loaded VF-specific firmware portion 404.

Virtualization on the APD 116 works as follows. The general firmware portion 402 manages time-slices on the APD 116 for the VMs (both the host VM 202 and the guest VMS 204) that share the APD 116. The general firmware portion 402 tracks the time-slices, and switches from initiating work on the APD 116 for one virtual function to initiating work for another virtual function on the APD 116.

In greater detail, the general firmware portion 402 reads one or more queues associated with a virtual function to obtain jobs to be performed. The general firmware portion 402 also performs one or more of the following operations. The general firmware portion 402 processes the job commands from the queue and, in some examples instructs the hardware of the APD 116 (e.g., the video processor 135, the graphics processing pipeline 134, and the compute units 132) for the purpose of processing the jobs. The general firmware portion 402 also reports back (e.g., to the processor 102) regarding completion of jobs in response to those jobs being complete. The VF-specific firmware portion 404 performs operations that are specific to the VM. Some of these operations include operations for processing the job commands from the queue and operations for interpreting the job commands and configuring the hardware of the APD 116. In general, the general firmware portion 402 performs operations that are common among the different VMs, while the VF-specific portion 404 performs operations that are different between the different VMs.

In addition to the above, the general firmware portion 402 manages world-switches, including determining when a world switch should occur and loading the VF-specific firmware portion 404. Also, upon completion of work for one VM when a world switch occurs, the general firmware portion 402 performs cleanup for the VM being switched out. Cleanup includes erasing or overwriting values used by the VF-specific firmware portion 404.

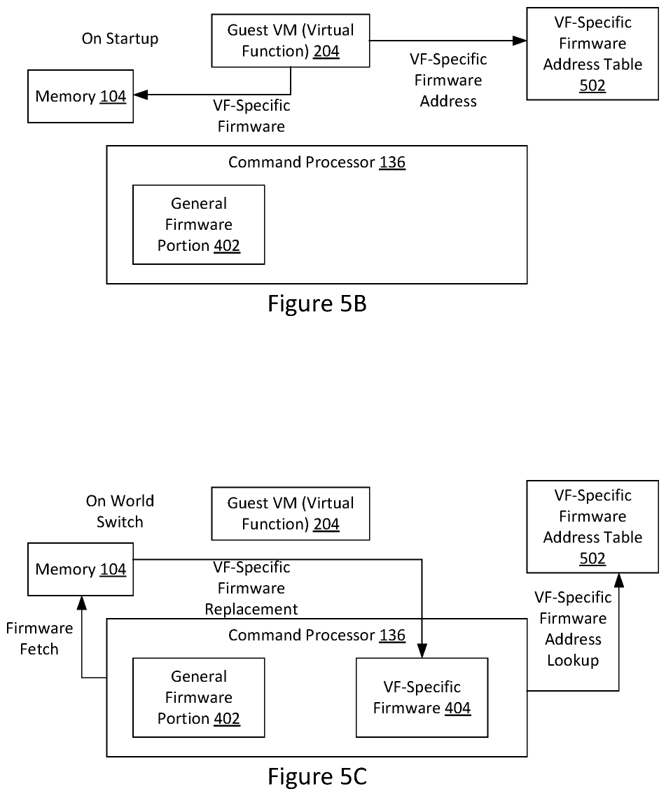

FIGS. 5A-5C illustrate example operations for loading firmware into the command processor 136. FIG. 5A illustrates an operation of loading a general firmware portion 402 into the command processor 136. On starting up a host VM 202, which is associated with a physical function, the host VM 202 causes the command processor 136 to load a general firmware portion 402. In some examples, the device 100 includes a security processor that verifies the integrity of the general firmware portion 402. More specifically, in some examples, the host VM 202 causes the command processor 136 to load the general firmware portion 402 in the following manner. First, the host VM 202 submits the general firmware portion 402 to the security processor. The security processor verifies the integrity of the general firmware portion 402 in any technically feasible manner (such as through verification of a cryptographic signing). Once the integrity is verified, the security processor loads the general firmware portion 402 into memory (e.g., memory 102 or a memory of the APD 116) and provides the address of that general firmware portion 402 to the command processor 136, which loads the general firmware portion 402 and begins operating according to the general firmware portion 402.

FIG. 5B illustrates operations associated with starting up a guest VM 204, according to an example. When a new guest VM 204 starts up on the device 100, the guest VM 204 requests the command processor 136 add an associated VF-specific firmware to a set of VF-specific firmware that are to be loaded onto the command processor 136 for world switches. More specifically, the guest VM 204 requests the VF-specific firmware to be loaded into memory and adds the address where the VF-specific firmware is loaded into memory to a VF-specific firmware address table 502. Again, in some examples, the guest VM 204 provides the VF-specific firmware to a security processor which verifies the integrity of the VF-specific firmware and loads the VF-specific firmware into the memory 104 (which can alternatively be a memory of the APD 116 or any other memory). The security processor provides the address of the VF-specific firmware to the guest VM 204 or command processor 136 for placement into the VF-specific firmware address table 502.

In various examples, the VF-specific firmware is specified by the APD driver 122 of a guest VM 204. In other words, such a driver 122 is the entity that provides the VF-specific firmware to the APD 116 for loading.

FIG. 5C illustrates operations associated with performing a world switch, according to an example. The command processor 136 performs a world switch, changing which VM 204 is being serviced by the APD 116. In the course of performing such an operation, the command processor 136 replaces the VF-specific firmware 404 for the VM 204 being switched out with the VF-specific firmware 404 for the VM 204 being switched in. To perform this operation, the general firmware portion 402 looks up the VF-specific firmware address from the VF-specific firmware address table 502 for the VM 204 being switched in. Then, the general firmware portion 402 loads the VF-specific firmware portion at that address from memory 104 into the command processor 136. Then, the general firmware portion 402 and VF-specific firmware 404 operate the APD 116 for the VM 204 that is switched in.

It should be understood that the general firmware portion 402 remains in the APD 116 when a world switch occurs. This means that the VF-specific firmware 404, and not the general firmware portion 402, is switched out when a world switch occurs.

In general, it should be understood that the general firmware portion 402 performs operations that are shared between each version of the firmware for the different guest VMs 204 (e.g., operations that are the same for any possible guest VM 204 that can be loaded) whereas the VM-specific firmware 404 performs operations that differ between different guest VMs 204.

In general, the general firmware portion 402 includes operations that are generic across the different guest VMs 204. In some examples, such operations include initialization operations, generic queue handling operations, generic job command processing operations, job completion reporting code, common hardware interface operations (e.g., operations that interface with the hardware of the APD 116), and other operations. The initialization operations include initialization of the APD 116 upon boot-up, including setting the values in registers, memories, or the like, that are required for operation. The generic queue handling operations are operations for reading queues (e.g., command queues into which an entity such as the processor 102 places job commands for execution by the APD 116), or otherwise performing operations on queues, that are the same for all different VMs 204. The generic job command processing operations are operations involved with processing the job commands placed into such command queues that are the same for all VMs 204. The job completion reporting code are operations for reporting to an entity such as the processor 102 that a job command is completed, and the common hardware interface operations are operations for configuring the hardware of the APD 116 to perform operations for the jobs, where such operations are the same among the different VMs 204.

In general, the VF-specific firmware portions 404 include operations that are specific to particular guest VMs 204. Such operations include code related to specific features, algorithms, or bug fixes (e.g., a fix in operations from one version of the VF-specific firmware 404 to another version of the VF-specific firmware 404) that vary from VM 204 to VM 204. For example, when a hardware vendor such as the designer or manufacturer of the APD 116 releases a new driver, the hardware vendor may update the driver to add new features, fix bugs, perform optimizations, or perform other operations. These updates are included in the VF-specific firmware portions 404.

The above techniques provide several benefits. Separating the firmware for the command processor 136 into generic and VF-specific portions reduces the amount of firmware that is to be loaded into the command processor 136 upon performing a world switch, since instead of loading the entirety of the firmware, only the VF-specific firmware portion 404 is loaded. In addition, switching only the VF-specific portion shortens the length of the world switch. More specifically, without such separation, a world-switch would involve loading much more code into the command processor 136 as well as completely re-initializing the APD 116, including the command processor 136. In addition, having a separate general firmware portion 402 and VF-specific firmware portion 404 provides extra security as compared with not separating these components out. Specifically, firmware loaded by the host/virtualization driver is more trusted in general than firmware loaded by a guest/VF driver, since the guest/VF driver is accessed by end users and may be subject to malicious manipulation, whereas the host/virtualization driver is generally only accessible to server administrators.

In some examples, the general firmware portion 402 pre-fetches a next VF-specific portion (e.g., into a cache) prior to actually performing a world switch, but in preparation for performing a world switch. More specifically, the general firmware portion 402 knows when a world-switch will occur and which VF is next to have a turn on the APD 116. Thus, the general firmware portion 402, in some examples, pre-fetches the VF-specific portion 404 for the subsequent VF, into the cache prior to the world-switch actually occurring. Then, when the world-switch occurs, and the general firmware portion 402 loads the next VF specific portion 404 from the memory subsystem, that loading is faster than if the pre-fetch did not occur, because the VF-specific portion is already in the cache which is more quickly accessed than a backing memory such as memory 104 or a general purpose memory of the APD 116.

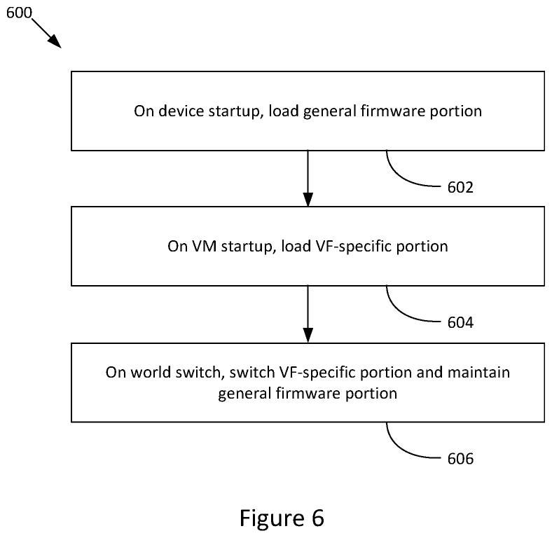

FIG. 6 is a flow diagram of a method 600 for operating an APD 116, according to an example. Although described with respect to the system of FIGS. 1-5C, those of skill in the art will understand that any system configured to perform the steps of the method 600 in any technically feasible order falls within the scope of the present disclosure.

At step 602, the command processor 136 loads a general firmware portion 402. In various examples, the general firmware portion 402 is associated with the physical function for the device APD 116. As described elsewhere herein, in some examples, the general firmware portion 402 represents a portion of the firmware that is “common” to all VMs 204 that would execute on the APD 116. The general firmware portion 402 also performs initialization for the APD 116, setting values in memories and registers necessary for operation of the APD 116. Additional details for startup and loading the general firmware portion 402 are provided with respect to FIG. 5A.

At step 604, a VM 204 starts up. The VM 204 has an APD driver 122 that specifies a VF-specific firmware portion 404. The VM 204 requests this VF-specific firmware portion 404 be loaded for use by the command processor 136. In some examples, the APD driver 122 requests a security processor to load the VF-specific portion 404 in memory. The security processor verifies the VF-specific portion 404, loads that portion 404 into memory, and provides the address to a VF-specific firmware address table 502, which the command processor 136 has access to. Additional details for starting up the VM 204 are provided with respect to FIG. 5B.

At step 606, the command processor 136 performs a world switch, from a first VF to a second VF. In this operation, the command processor 136 replaces a loaded VF-specific firmware 404 for the first VF to a VF-specific firmware 404 for the second VF. In various examples, the command processor 136 performs cleanup for the first VF, clearing values for the first VF and performing other necessary operations. Additional details for performing the world switch are provided with respect to FIG. 5C.

It should be understood that many variations are possible based on the disclosure herein. Although features and elements are described above in particular combinations, each feature or element can be used alone without the other features and elements or in various combinations with or without other features and elements.

In one example variation, the world switching operations of the command processor 136 are part of a different firmware than the general firmware portion 402.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the auxiliary devices 106, the auxiliary processors 114, the APD 116, the storage 108, the IO devices 117, the command processor 136, video processor 135, graphics processing pipeline 134, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, and output merger stage 318, are implemented fully in hardware, fully in software executing on processing units, or as a combination thereof. The host VM 202, guest VMs 204, applications 126, operating systems 120, APD drivers 122, management applications 123, host operating system 119, APD virtualization driver 121, hypervisor 206, firmware 401 including general firmware portion 402, and VF-specific firmware portion 404, represent software executing on a programmable processor. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for operating a device, the method comprising:
loading a general firmware portion into a device; and
for activation of a previously inactive virtual function through a world switch, activating a virtual-function specific firmware portion corresponding to the previously inactive virtual function.

2. The method of claim 1, wherein the general firmware portion remains activated during the activation of the previously inactive virtual function.

3. The method of claim 1, wherein the general firmware portion includes operations that are common for different virtual functions configured to execute on the device.

4. The method of claim 1, wherein activating the virtual-function specific firmware portion includes validating the virtual-function specific firmware portion by a security processor prior to loading the previously inactive virtual function into a memory.

5. The method of claim 1, wherein activating the virtual-function specific firmware portion comprises placing a first address into a virtual function-specific firmware address table.

6. The method of claim 5, wherein activating the virtual-function specific firmware portion comprises loading the virtual-function specific firmware portion using the first address.

7. The method of claim 1, further comprising, prior to the world switch occurring, pre-fetching the virtual-function specific firmware portion into a cache.

8. The method of claim 1, wherein activating the virtual-function specific firmware portion comprises replacing an old virtual-function specific firmware portion with the virtual-function specific firmware portion and maintaining the general firmware portion.

9. The method of claim 1, wherein the activating is performed by the general firmware portion.

10. A system comprising:
a memory; and
a processor configured to:
load a general firmware portion into a device; and
for activation of a previously inactive virtual function through a world switch, activate a virtual-function specific firmware portion corresponding to the previously inactive virtual function.

11. The system of claim 10, wherein the general firmware portion remains activated during the activation of the previously inactive virtual function.

12. The system of claim 10, wherein the general firmware portion includes operations that are common for different virtual functions configured to execute on the device.

13. The system of claim 10, wherein activating the virtual-function specific firmware portion includes validating the virtual-function specific firmware portion by a security processor prior to loading the previously inactive virtual function into the memory.

14. The system of claim 10, wherein activating the virtual-function specific firmware portion comprises placing a first address into a virtual function-specific firmware address table.

15. The system of claim 14, wherein activating the virtual-function specific firmware portion comprises loading the virtual-function specific firmware portion using the first address.

16. The system of claim 10, wherein the processor is further configured to, prior to the world switch occurring, pre-fetching the virtual-function specific firmware portion into a cache.

17. The system of claim 10, wherein activating the virtual-function specific firmware portion comprises replacing an old virtual-function specific firmware portion with the virtual-function specific firmware portion and maintaining the general firmware portion.

18. The system of claim 10, wherein the activating is performed by the general firmware portion.

19. A non-transitory computer-readable medium storing instructions that, when executed by a processor, cause the processor to perform operations comprising:
loading a general firmware portion into a device; and
for activation of a previously inactive virtual function through a world switch, activating a virtual-function specific firmware portion corresponding to the previously inactive virtual function.

20. The non-transitory computer-readable medium of claim 19, wherein the general firmware portion remains activated during the activation of the previously inactive virtual function.
